(19) United States
(12) Patent Application Publication
(10) Pub. No.: US 2005/0260329 A1
(43) Pub. Date: Nov. 24, 2005

(54) Production of liquid center filled confections

(76) Inventors: Christianita Yusuf, Fanwood, NJ (US); Gerald B. Cotten, Sparta, NJ (US); Sigismondo A. DeTora, Pearl River, NY (US); Jeffrey Sherman, Morristown, NJ (US)

Correspondence Address: HOLLANDER LAW FIRM, P.L.C., SUITE 305, 10300 EATON PLACE, FAIRFAX, VA, 22030, US

(21) Appl. No.: 10/977,585

(22) Filed: Oct. 29, 2004

Related U.S. Application Data
(63) Continuation-in-part of application No. 10/847,733, filed on May 18, 2004.

(51) Int. Cl. A23B 4/00

(52) U.S. Cl. 426/660; 426/516

(57) ABSTRACT

Liquid center filled confections, such as gummy or jelly candies or fruit snacks are continuously produced by co-deposition into a mold without candy tailing to obtain products with substantially uniform top and bottom walls and little, if any, shell breakage and liquid filling leakage or bleed-out problems. Excessive vertical decentering of the filling caused by substantial differences in specific gravity between the liquid filling component and the shell component and its accompanying production of thin or weak shell walls is substantially reduced or eliminated. A non-gellable liquid filling is deposited vertically off-center within a gellable shell, and the amount of sinking or floating is controlled so as to achieve an at least substantially centered product. The filling migration is limited by rapidly cooling the shell component below its gelling or setting temperature by use of a much colder filling component which itself does not gel or set at low temperatures.

### RELATED APPLICATIONS

This application is a continuation-in-part application of U.S. application Ser. No. 10/847,733, filed May 18, 2004 for “Confection Center Fill Apparatus and Method” in the names of Gerald Cotten and Donald Mihalich, the disclosure of which is herein incorporated by reference in its entirety.

### FIELD OF THE INVENTION

This invention relates to the production of liquid center filled confections such as liquid center filled jelly candy or gummy candy, and fruit snacks.

### BACKGROUND OF THE INVENTION

Confections such as gummy or jelly candy, or fruit snacks having a substantially large liquid center and a soft or chewy shell provide a highly desirable flavor burst and immediate textural sensation upon initial consumption. In the mass production of such liquid center filled confections using starch deposition equipment and methods a liquid filled product is formed, shaped, and is cured within a cavity of a starch mold. The enrobed center liquid filling generally remains in the same vertical orientation within the cavity for periods of about 18 to 48 hours while the initially liquid shell component gells or sets. If the shell component fed to the starch deposition apparatus or mogul is too viscous or gells or sets prematurely with the concentric deposition nozzle, undesirable clogging of the equipment occurs. Accordingly, to avoid clogging problems, both the shell component and the liquid filling component are liquids upon contact within the deposition nozzle. To conform to the shape of the cavity in the starch mold under the relatively low pressures provided by starch depositor, the shell component should be highly fluid or liquid upon deposition into the starch mold cavity. Also, in the mass production of liquid center filled confections using starch deposition equipment or methods, a low viscosity during deposition is desirable to avoid “candy tailing.” The problem of candy tailing is a phenomenon where a string of product runs from one deposit to the next, thereby inter-linking the desired individual sweets or pieces of confection.

However, in producing a liquid center filled confection using both a liquid shell component and a liquid filling component, the liquid center tends to sink or float or disperse within the liquid shell component before the shell component gells or sets within the starch mold cavity. Sinking or floating or dispersion of the liquid center occurs due to even very slight differences in specific gravities of the two components and the prolonged period of time needed for gelling or setting and curing in the same orientation within the starch mold cavity. The problems presented by excessive dispersion and vertical displacement of the liquid center are exasperated at increasing levels of liquid filling.

Excessive vertical displacement of the liquid filling from a centrally deposited location results in a bottom or top portion of the shell being thin and subject to breakage. Product pieces having vertically off-centered liquid fillings are more prone to leakage. Vertically off-centered products tend to result in “leakers” or product in which the center or filler component leaks out of the shell or is exposed due to weakness or thin spots in the shell.

Excessively thin top and bottom walls resulting from off-centered fillers may also limit the shapes into which the product can be molded, and may also limit the amount of filling because during deposition and molding, the generally cylindrical shape of the shell may be substantially changed. The change in shell shape for enrobing of the filler, and the change in shape to fill a mold cavity may further thin the shell walls.

The thinning problem may be further exacerbated when depositing into a mold cavity having a disproportionally longer vertical dimension or greater height, than horizontal dimension, or width or vice versa (i.e., tall and slender or short and wide). For a given piece weight, when depositing into a cavity of these proportions there is less leeway for increasing the shell flow rate so as to create thicker shell side, top, or bottom walls because the surface area of the piece (both shell and center) is much greater. To obtain thicker walls it may necessary to substantially reduce the amount of filler, thereby detracting from the sensation of a different texture or liquid center.

The leakage problem is of particular concern in the production of liquid or fluid filled confections. Leakage creates a sticky product and detracts from the liquid center sensation. The leakage may occur during material handling processes inherent in the manufacture of gummy or jelly sweets or fruit snacks. For example, leakage may occur after molding during oiling, polishing, and packaging operations as well as during transport and long term shelf storage in bags or pouches.

Another problem with off-centered products is that their appearance may be undesirable, even if the leaked filler is non-sticky. For example, for center filled products having a different colored or flavored center, the filler may be visible on the surface, or the different filler flavor may be tasted prematurely. Also, products having a transparent or translucent shell component and an off-centered or dispersed filling may appear less attractive than a centered, distinct filler even if the filler has not leaked to the outer surface of the shell component.

U.S. Pat. No. 5,626,896 to Moore et al discloses that filling thin liquid into jelly candy has not been well demonstrated by center shell depositing using a depositing nozzle that has a concentric design due to excessive leaks. Leaks are more likely to develop with jelly candy than with other types of candy, it is disclosed, because the density of sugary liquids, causes them to sink through hot jelly to the bottom of the mold. In the Moore et al method for making liquid-centered jelly candies by deposition in a starch mold, jelly candy is deposited to a level that half fills the mold. A small hard candy pellet is made from sugar, color, flavor, and acidulent. The hard candy pellet is centered on the jelly candy in each of the half full molds. A second deposit of warm jelly candy is filled over the pellets completing the candy pieces. The candy is cured at about 130° F. to about 140° F. for about 24-48 hours. During which time, moisture from the jelly candy migrates to and liquefies each candy pellet forming the liquid-centered jelly candy. The completed candy pieces are cured in the molds at about 130° F. to about 140° F. for about 24-48 hours. During the curing process, the moisture from the jelly migrates into and liquefies the sugar paste forming a liquid-centered jelly candy. Moore et al teaches away from contacting of a liquid shell component and a liquid filling component in a concentric nozzle in the continuous production of liquid center filled confections using a mogul or co-deposition equipment.

U.S. Pat. Nos. 4,847,098 and 4,853,236, European Patent Publication Nos. 333,510 A2, and 333,510 B1, and Japanese Patent Publication No. 2009346 published Jan. 12, 1990 each to Langler disclose the production of dual textured products using a concentric nozzle with a starchless molding depositor. A shell material having a temperature of about 215° F. to about 220° F. is fed to the starchless molding depositor which is equipped to deposit the center filling. The center is introduced at ambient temperature from a separate unheated hopper. A nozzle assembly brings the center and shell material together to the concentric nozzle where they are simultaneously deposited on a coated “U” board where they are allowed to cool to ambient temperature. The dual textured food products may be fruit snack pieces comprising a soft, supportive, fruit-containing shell portion and a second, more fluid, variably textured core portion. The shell portion can comprise a dehydrated fruit puree composition. In the products of U.S. Pat. No. 4,847,098 the core portion can comprise w/o emulsions characterized by low fat levels and defined gelled phases. In the products of U.S. Pat. No. 4,853,236 the core portion can comprise an o/w emulsion to create a hydrophobic, liquid fat barrier between the portions. The filling portion, it is disclosed, is perceived as being fluid upon consumption even though at rest the portion may be dimensionally stable, and is believed to be a thixotropic gel. The emulsified fillings of Langler may thus not provide a rush or gush of filling upon initial consumption as would a non-emulsified, non-gelling liquid filling. Moreover, use of an emulsion as a center filling requires additional method steps and equipment for forming each phase of the emulsion and for emulsifying the two phases. In addition, an emulsifier is required to form the emulsion which may result in off-flavors or the use of non-natural ingredients.

U.S. Pat. Nos. 5,146,844 and 5,208,059 each to Dubowik et al disclose that shaped, dual textured products of U.S. Pat. Nos. 4,847,098 and 4,853,236 to Langler make it difficult to develop apparatus for fabricating such pieces on an industrial scale. In the apparatus and method of Dubowik et al a cavity formed in and defined by abutting inner surfaces of first and second plates is moved along a circuitous path. The circuitous path has a first portion where the first and second plates are abutting together and where the cavity is filled with food material. In the second portion of the path the first and second plates are spaced from each other allowing the removal of the hardened food piece from the cavity. First food material is initially extruded to fill the bottom of a cavity, then the first food material is coextruded with and encircles a second food material, and finally the first food material is extruded to fill the top of the cavity. The first food material is provided to a food injection manifold heated to a temperature in the order of 150° F. to 180° F. (66° C.-82° C.) whereas the second food material is provided to the food injection manifold at a temperature range in the order of 50° F. (10° C.) to room temperature. In the methods and apparatus of Dubowik et al, moguls or starch deposition equipment where the product remains in the same vertical orientation in a mold cavity for an extended period of time for gelling or setting is not employed.

U.S. Pat. No. 6,528,102 to Coyle et al discloses processes for the co-deposition of a two component fruit snack confection including a fruit snack material jacket and a distinct center filling. In at least one embodiment, the center filling is jam like and is jelled in part by the action of pectin in the presence of food grade acid. A liquid filling may contain sweetener, corn syrup, sorbitol, water, acid, natural and artificial flavoring and other minor ingredients. The process utilized incorporates mass flow meters to monitor the specific gravities of the jacket and center filling to keep the specific gravities of the center material and the jacket substantially the same in the creation of the multi-component fruit snack. Controlling the specific gravities of the center and the jacket materials so that they are about the same, it is disclosed, reduces the tendency of the filling to migrate upwards or downwards in the confection. For a 2% fill of center relative to the jacket material, up to a 3% difference between the specific gravities was found to be tolerable. For an 18% center fill, a specific gravity difference of only about 0.5% was found tolerable to consistently produce confections wherein the center material is maintained within the outer jacket. However, the continuous control of specific gravities within such narrow tolerances requires expensive equipment. Additionally, the process for controlling the specific gravities generally requires the modification of amounts and types of ingredients employed thereby varying the composition of the final product, and may sacrifice textural and flavor attributes, impair microbial stability, or require non-natural ingredients. For example increasing the water content of a corn syrup-based liquid filling component to reduce its specific gravity may adversely increase the water activity. The increase in water activity may lead to undesirable moisture migration or other ingredient migration between the filling and shell materials or to microbial instability.

The present invention provides methods which solve both candy stringing and filler leakage or bleed-out problems in producing starch deposited, liquid center filled confections, such as gummy candy, jelly candy, and fruit snacks. In accordance with the present invention, low viscosity, liquid shell and filler components may be employed to avoid candy stringing. The liquid shell and filling components may have substantially different specific gravities upon contact, but substantial decentering of the filler which creates weak top and bottom shell walls does not occur during extended gelling, setting, and drying times in a single vertical orientation in a starch mold cavity. The specific gravities of the liquid shell and filling components may be substantially different at high filling content levels. Expensive equipment for precise maintenance of the specific gravities within close tolerance is not needed to avoid substantial sinking or floating of the filling and to achieve substantially vertically centered liquid fillings and reduced breakage and leakage.

Center-filled confections obtained using the methods of the present invention have substantially uniformly thick walls, and are durable during material handling processes employed after deposition and molding such as oiling, polishing, and packaging. The products exhibit long term shelf life in bags or pouches without substantial leaking or bleed-out of filling, are non-sticky, have a desirable appearance, even when the shell is translucent or transparent thereby making the filling component visible through the shell. The products contain a high weight percentage of filling and may be produced in mold cavities having a greater depth than width or vice versa without resulting in weak, leaky top and bottom shell walls. Chewy or soft shell walls which upon initial mastication provide a burst of liquid filling may be readily obtained in accordance with the present invention.

The methods of the present invention at least substantially prevent clogging of concentric flow nozzles of Moguls or starch depositors. The methods provide greater freedom in choosing shell and filling compositions for enhanced flavor and texture without undesirable moisture migration or sacrificing microbial shelf stability. Shell and filling compositions which are both in liquid form at the time of contact may be employed without the need for using thixotropic gell fillings, emulsified w/o or o/w compositions, or emulsifiers which may adverse affect flavor, and without requiring non-natural ingredients.

### SUMMARY OF THE INVENTION

Liquid center filled confections such as gummy candies, jelly candies, and fruit snacks, may be produced using Mogul or starch deposition techniques and equipment from liquid components having substantially different specific gravities in accordance with the methods of the present invention. The confections are produced with well-centered fillings, high filling amounts, and thick substantially uniform top and bottom walls which do not exhibit substantial, if any leakage or bleed-out. Low viscosity shell and filling components which are highly fluid may be employed so as to avoid candy tailing in the deposition process and to obtain liquid centers without substantial decentering of the filler. Leaky products are avoided by reducing vertical displacement of a non-gelling, liquid filling within a gellable shell in a starch deposition product where the filling and the shell have substantially different specific gravities. The reduction is achieved by depositing the filling vertically off-center with the gellable shell. The filling is then permitted to sink or float due to the differences in specific gravities. However, the amount of sinking or floating is limited so as to achieve an at least substantially centered product by rapidly cooling the shell component with the much colder filling component. Colder filling causes the shell to set or gell sufficiently to substantially impede or prevent further vertical displacement of the filling when it travels to or reaches the vertical center of the shell. Also, at the time of contact of the shell component and the filling component, the shell component temperature is kept low, generally slightly above the gelling or setting temperature of the shell component. Use of a low shell component temperature reduces the amount of cooling needed in the mold cavity without premature gelling of the shell component within the depositing nozzle.

In accordance with embodiments of the present invention, a non-gelling, liquid filling component may have a temperature of less than or equal to about 120° F., preferably less than or equal to about 100° F., most preferably less than or equal to about 75° F. when it contacts the gellable, liquid shell component. The gellable shell component includes at least one gelling agent which sets upon cooling. Upon contact with the filling component within the concentric depositing nozzle, the shell component may have a temperature of about 160° F. to about 220° F., preferably from about 180° F. to about 200° F., most preferably from about 185° F. to about 195° F. The shell component and the filling component may have specific gravities which differ from each other by at least about 3% upon contact. The amount of the liquid filling component may be least about 10% by weight, based upon the total weight of the liquid filling component and the shell component. In preferred embodiments, pectin and/or carrageenan in a total amount of from about 0.5% by weight to about 5% by weight, more preferably from about 0.8% by weight to about 2.5% by weight, based upon the weight of the gellable liquid shell component, alone or in combination with other gelling agents, such as gelatin, in the gellable shell component helps reduce vertical displacement of non-gelling liquid centers. Use of a shell component codeposition or filling contact temperature which is preferably about 5° F. to about 10° F. higher than the gelling or setting temperature of the liquid, gellable shell component avoids premature gelling of the shell component while achieving rapid gelling of the shell component which substantially reduces vertical displacement of the liquid, non-gelling filling component The final products may possess chewy or soft shell walls which upon initial mastication provide a burst or gush of liquid filling.

### DETAILED DESCRIPTION OF THE INVENTION

The present invention provides a method for producing liquid center filled confections, such as gummy or jelly candies or fruit snacks, using a Mogul or starch depositor without excessive vertical decentering of the filling caused by substantial differences in specific gravities of the filling component and the shell component. The method of the present invention substantially reduces shell breakage and liquid filler leakage or bleed-out problems without the need for adjusting formulations so as to achieve substantially the same specific gravities at the expense of textural and flavor attributes. Also, expensive control equipment for controlling specific gravities within tight tolerances is not required with the process of the present invention. Excessive vertical decentering of the filling and its accompanying production of thin or weak shell walls is avoided by depositing a non-gellable liquid filling vertically off-center within a gellable shell which sets or gels when its temperature is reduced. The liquid filling is permitted to sink or float due to the differences in specific gravities. However, the amount of sinking or floating is limited so as to achieve an at least substantially centered product by rapidly cooling the shell component below its gelling or setting temperature. Cooling of the shell component is achieved by use of a much colder filling component which itself does not gell or set at low temperatures. The colder filling helps to cool the shell at the interface of the shell and filling and causes the shell to set or gell. The extent of setting or gelling of the shell is sufficient to substantially impede or prevent substantial further vertical displacement of the filling after it has traveled to or reaches the vertical center of the shell. Also, low, liquid shell component temperatures are employed at the time of contact with the liquid filling component so as to reduce the amount of cooling needed in the starch mold cavity. It is believed that the cooler filling helps to form a gelled skin or area of shell component about the filling at the interface with the filling component. As the internal cooling continues and the gelled area grows outwardly, excessive vertical movement of the filling is impeded. The internal cooling is supplemented by external cooling provided by the starch mold which further impedes vertical displacement of the filling during prolonged curing and drying times at the same vertical orientation within the starch cavity. In embodiments of the invention, the starch of the starch mold may be cooled to a temperature of less than about 85° F. prior to depositing of the partially enrobed filling component into the mold cavity

The liquid center filled confections may be produced batch-wise or continuously using commercially available Mogul or starch depositor equipment such as starch depositors manufactured by NID Pty. Ltd., Winkler Dunnebier GmbH, Werner Makat GmbH, and American Chocolate Mould Co. The commercially available Moguls or starch depositors for dispensing the shell and filler components into a mold generally include one or more coextrusion nozzles or die blocks secured to a die head or manifold. In center fill manifold and nozzle combinations used for starch depositing, a center product or filler component runs down an inner tube down the center or middle of the manifold nozzle to near the extraction point of the nozzle. At this point it is surrounded by the shell component which has been flowing down the annular space in the nozzle between the nozzle outer wall and the inner tube.

In accordance with the method of the present invention, the temperature of the non-gelling filling component at the time of contact with the liquid gellable shell component in the co-deposition nozzle should be as low as possible for more rapid cooling of the shell component. However, the temperature should not be so low that the viscosity increases to a point where clogging of the coextruder or Mogul nozzle or manifold occurs or high back pressures are produced in the manifold or upstream material handling equipment. In embodiments of the present invention, the temperature of the non-gelling liquid filling component may be less than or equal to about 120° F., preferably less than or equal to about 100° F., most preferably less than or equal to about 75° F., but generally greater than or equal to about 45° F., for example from about 45° F. to about 70° F., or from about 55° F. to about 65° F.

Cooling to achieve the desired liquid filling component contact temperature may be accomplished by cooling the filling component prior to introduction into the Mogul or starch co-depositor under ambient temperature conditions and/or with a conventional heat exchanger or cooling unit.

The temperature of the liquid, gellable shell component at the time of contact with the liquid non-gelling filling component in the co-deposition nozzle should be as low as possible for more rapid gelling or setting of the shell component and to reduce the amount of cooling needed to sufficiently set or gel the shell so that it slows or impedes vertical travel of the filling component. However, the shell temperature should not be so low that the shell component gells or sets prematurely in the Mogul manifold or co-deposition nozzle or in upstream material mixing and handling equipment. The viscosity of the shell component should not be permitted to increase to a point where excessive candy tailing or clogging of the coextruder or Mogul nozzle or manifold occurs or high back pressures are produced in the manifold or upstream material handling equipment. In embodiments of the invention, the contact temperature of the shell component may be slightly higher than the gelling or setting temperature of the shell component or gelling agent. The gelling or setting temperature of the shell component or gelling agent may be readily determined experimentally by measuring the temperature of the shell component as it is cooled and observing the temperature at which its viscosity suddenly or rapidly increases or a jam-like consistency is obtained. In embodiments of the invention, the contact temperature may be less than about 25° F., preferably less than about 20° F., for example from about 1° F. to about 15° F., more preferably from about 5° F. to about 10° F. higher than the gelling or setting temperature. The gelling or setting temperature will vary depending upon the type and amount of the gelling agent employed. In embodiments of the present invention, the temperature of the shell component upon contact with the filling component may range from about 160° F. to about 220° F., preferably from about 180° F. to about 200° F., more preferably from about 185° F. to about 195° F., for example from about 188° F. to about 193° F.

Cooling to achieve the desired liquid shell component contact temperature may be accomplished by cooling the shell component prior to introduction into the Mogul or starch co-depositor under ambient temperature conditions and/or with a conventional heat exchanger or cooling unit.

In embodiments of the present invention, the difference in specific gravities of the liquid non-gelling filler component and the liquid, gellable shell component upon contact in the concentric co-deposition nozzle and upon deposition into the starch mold cavity may be 2.5% or more, generally at least about 3%, more generally at least about 5%. For example, the difference in specific gravities may range from about 3.5% to about 10%, generally from about 4% to about 7%. Generally; as the difference in specific gravities increases, the weight percentage of filling which may be employed decreases because the rate of vertical movement of the filling increases thereby providing both less time for the shell to be cooled via the colder filling in contact with it as well as a larger surface area of shell in direct contact with the center to be cooled. However, using the cooling technique of the present invention, unexpectedly high filling levels may be achieved even with substantial differences in specific gravity. In embodiments of the present invention, when the specific gravities differ by 2.5% or more, the amount of the liquid filling component may be at least about 10% by weight, preferably at least about 15% by weight, for example from about 20% by weight to about 25% by weight, or more, based upon the total weight of the shell and filler components, while achieving an unexpectedly low level of product leakage.

The viscosities of the gellable liquid shell component and the non-gelling liquid filling component at the time of contact within the co-deposition nozzle and upon deposition into the starch mold cavity may differ substantially from each other. Upon deposition into the starch mold cavity the viscosity of the liquid shell component is generally much greater than the viscosity of the liquid filler component but sufficiently low so as to avoid substantial candy tailing.

In embodiments of the present invention the ratio of the viscosity of the liquid shell component to the viscosity of the liquid filling component at the time of their contact in the co-deposition nozzle and upon co-deposition within the starch mold cavity may be at least about 1.5:1, generally at least about 3:1, for example from about 3.5:1 to about 5:1.

In embodiments of the present invention the amount of filling component vertical off-centering or displacement employed may be measured along a vertical centerline of the co-deposited piece of confection. It may be calculated as a percentage of the difference in thickness of the top and bottom shell walls compared to the total thickness of the top and bottom shell walls along the same vertical line. Thus, for a filling whose top surface is equal to the top surface of the shell, the percentage vertical displacement would be 100%. For a filling which has equally thick bottom and top shell walls, the percentage vertical displacement would be 0%.

For example, in accordance with an embodiment of the present invention, a co-deposited confection may be produced having a maximum vertical dimension or height along its centerline of 17 mm and a filling vertical dimension or height along the same line of 8 mm. The filling may be initially deposited vertically off-center so that the top wall thickness is 3 mm and the bottom wall thickness is 6 mm along the centerline. If the filling was initially deposited to be centered within the shell, the shell top and bottom wall thicknesses would each be 4.5 mm. The percentage initial vertical displacement of the deposited filling would be calculated as (6 mm−3 mm)/(6 mm+3 mm)×100%=33.3%. After the initial deposition, the filling sinks due to the higher specific gravity of the filling compared to that of the shell. If the filling and shell temperatures are controlled so that the shell sets quickly and the filling sinks 4 mm, the thickness of the top wall will be 7 mm and the bottom wall thickness will be 2 mm. The percentage final vertical displacement would be calculated as (7 mm−2 mm)/(7 mm+2 mm)×100%=55.5%. However, if the filling were initially deposited so that it was vertically centered (a vertical displacement of 0%) and the filling sank 4 mm, the top wall thickness would be 8.5 mm and the bottom wall thickness would be only 0.5 mm and much more prone to breakage and leakage. In the latter instance, the percentage final vertical displacement would be calculated as (8.5 mm−0.5 mm)/(8.5 mm+0.5 mm)×100%=88.9%.

In embodiments of the present invention, the percentage vertical displacement of the filling component upon initial deposition may range up to about 80%, generally from about 10% to about 60%, for example from about 25% to about 50%. The final vertical displacement, achieved after any sinking or floating of the filling component is completed, may range from about 0% to about 80%, preferably, less than about 60%, for example from about 10% to about 50%. Although essentially no vertical displacement is most desirable in the final product, higher displacements may be employed while achieving at least substantially uniformly thick top and bottom walls which are sufficiently thick to at least substantially prevent or eliminate breakage of the shell component wall and leakage of the liquid filling component. In embodiments, the liquid center-filled confections may have a shell casing with a substantially thicker top wall than bottom wall or vice versa. However, each of the bottom and top walls will each still have an at least substantially uniform thickness devoid of weak spots.

In embodiments of the present invention wherein the specific gravity of the liquid filling component is greater than the specific gravity of the liquid shell component, the liquid filling component is vertically displaced above the center of the confection prior to complete gelling or setting of the shell component. The liquid filling component may be permitted to descend or sink so that upon completion of gelling or setting of the shell component the liquid filling component is substantially vertically centered between the top and bottom walls of gelled or set shell component of substantially equal thickness.

In embodiments of the present invention where the specific gravity of the liquid filling component is less than the specific gravity of the liquid shell component, the liquid filling component is vertically displaced below the center of the confection prior to complete gelling or setting of the shell component. The liquid filling component may be permitted to ascend or rise so that upon completion of gelling or setting of the shell component the liquid filling component is substantially centered between top and bottom walls of gelled or set shell component of substantially equal thickness.

The vertical off-center positioning of the liquid center filling in accordance with the present invention may be controlled using known starch deposition equipment and methods for vertical centering of fillings. Generally, pistons are employed to control the amount or flow of the shell component and the filling component so as to enrobe the filling component within the shell component as it is deposited into the cavity of a mold. The conventional starch deposition apparatus which may be employed in the present invention for continuously producing liquid center filled confections, such as a gummy or jelly candies or fruit snacks may include at least one die block or nozzle assembly contained in a die head or manifold. The nozzle assembly has an inner nozzle which conveys the center or filler component through an inner passageway. The inner nozzle is located within an outer nozzle which creates an annular passageway for conveyance of the shell component. The shell component may be supplied to the outer nozzle from a temperature controlled or jacketed shell component hopper. The outer nozzle is also in flow communication with an outer or shell component piston which moves between a first and a second position to deposit the shell component. The center or filler component is supplied to the inner nozzle from a temperature controlled or jacketed filler component hopper. The inner nozzle is in flow communication with an inner or filler component piston, which moves between a first and a second position to deposit the center or filler component. The shell component and the filler component are co-deposited in a mold having mold cavities or impressions. The cavities or impressions are preferably created in a starch-based material which is to be filled with the co-deposit of shell and filler components. In the production of gummy or jelly candies, or fruit snacks a starch mold is generally preferred due to its flexibility in enabling changing shapes easily and removing additional moisture from the product in the curing room through a wicking type action. Semi-rigid molds or flexible molds such as silicone rubber molds, or rigid molds such as molds cast of metal, as used in hard candy production may also be employed for varying confections.

The pistons may be controlled in conventional manner to enrobe the filler component within the shell component by pulsating or controlling the relative flow rates of the shell and filler components. The pistons may be employed to stop, retract or reverse, decrease, or increase flow of the components emanating from the outer and inner nozzles as they are deposited into the mold impressions or cavities.

For example, the depositing nozzle may be positioned close to the mold cavity. By controlling the pistons, the shell component flows into the cavity first. Subsequently, the filler component begins to be deposited. The shell component may then spread laterally within the cavity to take the shape of the cavity in the starch material while the filling material is still being injected and partially enrobed in the shell component. Injection of the center or filler component may then be ceased and the filling piston is reversed to reverse the flow or suck back the filler component. However, the shell component continues to be deposited and causes the deposited, partially enrobed filling component to begin to separate from the filling component still within the inner nozzle. The filling component connecting the deposited center filling to the center filling still within the inner nozzle narrows first to a neck and then to a finer connection.

Finally, the depositing of both the center filling component and the shell component is stopped, and the starch tray or mold and the starch cavity or impression is moved away from the deposition nozzle to completely enrobe the filler component within the shell component.

Downward filling migration tendency resulting from a higher filling specific gravity than shell specific gravity may be compensated for by use of the pistons to increase flow of the shell component prior to and during deposition of the filling component. The increased flow compared to the flow after deposition of the filling creates a bottom wall which is initially thicker than the top wall. Then, the enrobed filling sitting in the mold cavity may be permitted to sink or migrate downwardly within the shell component and come to rest so that the top wall thickness is substantially the same as, or somewhat thinner than, or thicker than the thickness of the bottom wall.

Upward filling migration tendency resulting from a lower filling specific gravity than shell specific gravity may be compensated for by use of the pistons to increase flow of the shell component during and after deposition of the filling component. The increased flow compared to the flow prior to deposition of the filling creates a top wall which is initially thicker than the bottom wall. Then, while in the mold cavity, the enrobed filling is permitted to float or migrate upwardly within the shell component and come to rest so that the top wall thickness is substantially the same as, somewhat thicker than, or thinner than the thickness of the bottom wall.

However, in those embodiments where the filling comes to rest so that the top and bottom walls do not have substantially the same thickness, each still have an at least substantially uniform thickness devoid of weak spots. Also, the filling is substantially more vertically centered than would be obtained without the combination of initial vertical centering and temperature controls of the present invention.

In preferred embodiments of the present invention, commercially available Moguls or starch co-depositors are modified to prevent substantial horizontal displacement of the filling component within the shell component as disclosed in copending, commonly assigned U.S. application Ser. No. 10/847,733, filed May 18, 2004 for “Confection Center Fill Apparatus and Method” in the names of Gerald Cotten and Donald Mihalich, the disclosure of which is herein incorporated by reference in its entirety. As disclosed therein, generally, the commercially available manifolds are machined to have only one entry point for the shell component per cavity or nozzle. However, in the production of gummy or jelly candies or fruit snacks, as the shell portion is very fluid to avoid candy tailing, the shell component tends to preferentially flow down the side at which it was introduced into the annular space in the manifold. As a result, the center product is preferentially forced to the far side (side furthest away from the point of shell introduction in the manifold) in the stream emanating from the nozzle tip. This preferential flow of the shell component along the single side of introduction in the annular space and displacement of the filling by the shell component results in horizontally off-centered product. The loss in concentricity tends to be more pronounced when the viscosity of the filler component is substantially less than the viscosity of the shell component, such as in liquid center filled products.

Horizontal displacement of the filling is avoided or reduced by distributing the shell component at least substantially evenly throughout the annular passageway of each manifold nozzle prior to contact of the filler component and the shell component so that the filler component is at least substantially centered within the shell component when the filler and shell components are contacted. Obtaining even distribution of the shell component in the manifold nozzle involves preventing excessive flow along a side or portion of the annular passageway which is at or adjacent to a single entry point of the shell component into the annular passageway. In retrofitting such apparatus a removable, apertured disk insert may be employed to divert flow of the shell component away from the side or portion of the annular passageway where the single entry point of the shell component is located toward an opposing side or portion of the annular passageway. As a result, excessive flow of the shell component which tends to push or redirect the filling component towards an opposing side or portion of the annular passageway and create substantially non-concentric center filled confections is avoided.

As disclosed in U.S. application Ser. No. 10/847,733, filed May 18, 2004 the insert may include a mechanical locating device or member to locate or align and lock down the insert to a position where the shell component enters the manifold cavity or annular passageway. Alternatively, the insert could have a notch or notches and the corresponding center tube may have a key way type notch or a series of notches or cogs such that it can be positioned and locked in place. The insert has a series of holes or apertures to balance the flow of the shell component down the annular passageway of the nozzle when the insert is located or locked in the proper location with respect to the single entry point. In preferred embodiments, the total cross-sectional area of the flow distributing apertures of the insert is greater than or substantially equal to the cross sectional area of the shell component entry point so as to at least substantially maintain a constant mass flow rate of the shell component and avoid a substantial increase in back-pressure in feeding of the shell component through the annular passageway.

For non-retrofitted apparatus, as disclosed in U.S. application Ser. No. 10/847,733, filed May 18, 2004 the flow distributing apertures may be drilled or bored into a downstream manifold plate rather than being provided in a removable insert disk. The bores may be generally parallel to the central longitudinal axis of the manifold nozzle and be located away from the single entry point into the annular passageway. As in the embodiment where an apertured disk insert is employed, the flow distributing manifold bores may be located to divert flow of the shell component away from the side or portion of the annular passageway where the single entry point of the shell component is located toward an opposing side or portion of the annular passageway.

In other non-retrofitted or non-disk insert embodiments disclosed in U.S. application Ser. No. 10/847,733, filed May 18, 2004, even distribution of the shell component in a manifold nozzle involves feeding the shell component at least substantially evenly through at least two substantially opposing entry points into the annular passageway of each manifold nozzle so that the opposing flows from the entry points maintain the flow of the filler or filling component at least substantially along a central longitudinal axis and create substantially concentric center filled confections. The manifold is constructed so that the multiple passageways for feeding the shell component to the plurality of entry points for each annular passageway have at least substantially the same resistance to flow or at least substantially the same path lengths.

Thus, in preferred embodiments of the present invention, a liquid center filled confection such as a gummy or jelly candy or fruit snack is obtained with the liquid filling both at least substantially vertically and horizontally centered within the shell component. The preferred liquid center-filled confections of the present invention, have shell component side walls and top and bottom walls which are each at least substantially uniformly thick and essentially devoid of thin or weak spots, and completely enrobe the filler component. The longitudinal axis of the center filling is at least substantially the same as the longitudinal axis of the shell component and the longitudinal axis of the entire confection. The thickness of each of the side walls are at least substantially equal to each other as a result of horizontal centering of the filling component.

Any conventional filling or filler materials and shell materials for gummy candies, jelly candies, and fruit snacks, may be used in the methods of the present invention for making liquid center filled confections. The liquid center filled confections may be fat-free or sugar-free. For example, the shell and filler components may include one or more of fruit juices, fruit concentrates, and fruit purees, one or more sweeteners such as high fructose corn syrup, corn syrup, sugars such as sucrose and dextrose, maltitol syrup, corn syrup solids, maltodextrins, and sorbitol, one or more synthetic, artificial or non-nutritive sweeteners, one or more edible acids such as citric acid, malic acid, and tartaric acid, one or more edible buffering agents such as sodium citrate or potassium citrate, coloring, flavoring, preservatives, and nutrients such as vitamins and minerals. The gellable, liquid shell component may contain one or more gelling agents such as pectin, gelatin, carrageenan, agar, modified food starches, such as modified corn starch, and other gums and hydrocolloids. Pectin and gelatin are preferred gelling agents for use in the shell components. They are natural products and provide clean, translucent, or transparent gels. The gelatin bloom may range from about 200 to about 300. A high methoxy pectin which sets up in the presence of acid is most preferred. A gelling agent or thickening agent is not needed in the non-gelling liquid filling component.

In embodiments of the present invention, the gellable liquid shell component or shell slurry may contain from 0% by weight to about 60% by weight, preferably from about 40% by weight to about 55% by weight of one or more corn syrups, from about 0% by weight to about 45% by weight, preferably from about 20% by weight to about 35% by weight sucrose, from about 0% by weight to about 80% by weight other sweeteners such as dextrose, corn syrup solids, maltitol syrup, sorbitol, and maltodextrin, about 0.01% by weight to about 10% by weight, preferably from about 1% by weight to about 8% by weight, of at least one gelling agent such as pectin, gelatin, carrageenan, agar, modified starch, such as modified corn starch, and other gums and hydrocolloids, from about 0% by weight to about 30% by weight, preferably from about 2% by weight to about 15% by weight in fruit products, of at least one fruit ingredient such as fruit puree, fruit juice concentrate, and fruit juice, about 0.01% by weight to about 5% by weight, preferably from about 0.5% by weight to about 2.5% by weight of at least one buffering agent such as sodium citrate, and potassium citrate, from about 0.01% by weight to about 5% by weight, preferably from about 0.5% by weight to about 3% by weight of at least one acidic agent such as citric acid, malic acid, and tartaric acid, from about 0% by weight to about 5% by weight, preferably from about 0% by weight to about 2% by weight of at least one coloring agent or color, about 0.01% by weight to about 5% by weight, preferably from about 0.1% by weight to about 2% by weight of a flavoring agent or flavor, about 0% by weight to about 5% by weight, preferably from about 0.01% by weight to about 1% by weight of at least one vitamin, such as vitamin C, and effective sweetening amounts of any optional one or more synthetic, artificial or non-nutritive sweeteners, where the percentages are based upon the total weight of the gellable liquid shell component or shell slurry and add up to 100% by weight. An acid and buffering agent may be employed to adjust the gelling or setting rate of the gel without adversely affecting a desired level of sweetness or sourness in the final product. In embodiments of the invention, the acid and the buffering agent levels may be adjusted to provide a shell pH of about 3 to about 3.5, preferably from about 3.2 to about 3.4.

In accordance with preferred embodiments of the present invention, a gelling agent which sets quickly is employed so that the shell component sets quickly and reduces the vertical displacement of the non-gelling liquid filling component. Pectin and carrageenan may set or gel faster than other gelling agents such as gelatin and modified food starches. Accordingly, to help reduce vertical displacement of non-gelling liquid centers, it is preferable to employ pectin and/or carrageenan alone or in combination with other gelling agents, such as gelatin, in the gellable shell component of the present invention. If the amount of the pectin and/or carrageenan is too low, the time it takes for the shell component to gel tends to increase, and the vertical displacement of the non-gelling liquid filling component tends to increase. If the amount of the pectin and/or carrageenan is too high, the shell component may set or gel too quickly and/or the texture of the final product may be too hard or rubbery, rather than soft and chewy. Excessively rapid gelling may result in premature gelling of the shell component in the Mogul feed hopper or in the codeposition nozzle which causes clogging of the nozzle or candy tailing upon codeposition in the starch mold. The premature gelling tends to be exacerbated by the use of gellable liquid shell component codeposition or filling contact temperatures which are slightly above the gelling or setting temperature of the shell component. In accordance with embodiments of the present invention, premature gelling of the shell component is avoided while achieving a soft, chewy texture and rapid gelling of the shell component at temperatures slightly above the gelling or setting temperature of the shell component so that vertical displacement of the liquid, non-gelling filling component is substantially reduced. In preferred embodiments, pectin and/or carrageenan is employed in the shell component in a total amount of from about 0.5% by weight to about 5% by weight, more preferably from about 0.8% by weight to about 2.5% by weight, based upon the weight of the gellable liquid shell component, with a shell component codeposition or filling contact temperature which is about 1° F. to about 15° F., more preferably about 5° F. to about 10° F., higher than the gelling or setting temperature of the liquid, gellable shell component.

In embodiments of the present invention, the non-gelling liquid filling component or filling slurry may contain from 0% by weight to about 95% by weight, preferably from about 35% by weight to about 90% by weight of one or more corn syrups, from about 0% by weight to about 60% by weight, preferably from about 35% by weight to about 50% by weight sucrose, from about 0% by weight to about 95% by weight other sweeteners such as dextrose, corn syrup solids, maltitol syrup, sorbitol, and maltodextrin, from about 0% by weight to about 30% by weight, preferably from about 2% by weight to about 15% by weight in fruit products, of at least one fruit ingredient such as fruit puree, fruit juice concentrate, and fruit juice, about 0% by weight to about 5% by weight, preferably from about 0.5% by weight to about 2% by weight of at least one buffering agent such as sodium citrate, and potassium citrate, from about 0.01% by weight to about 5% by weight, preferably from about 0.5% by weight to about 3% by weight of at least one acidic agent such as citric acid, malic acid, and tartaric acid, from about 0% by weight to about 5% by weight, preferably from about 0% by weight to about 2% by weight of at least one coloring agent or color, about 0.01% by weight to about 5% by weight, preferably from about 0.1% by weight to about 2% by weight of a flavoring agent or flavor, about 0% by weight to about 5% by weight, preferably from 0% by weight to about 1% by weight of at least one vitamin, such as vitamin C, and effective sweetening amounts of any optional one or more synthetic, artificial or non-nutritive sweeteners, where the percentages are based upon the total weight of the non-gelling liquid filling component or filling slurry and add up to 100% by weight.

The gellable liquid shell component and the non-gelling liquid filling component may each be non-emulsified, single phase components and may be formulated to contain only natural ingredients. For example, in preferred embodiments of the invention, natural gelling agents such as pectin, carrageenan, and gelatin may be employed without the need for a non-natural gelling agent such as a modified starch gelling agent. The buffering agent helps to prevent premature gelling or pre-gelling of the gelling agent in the shell component prior to contact with the filling component in the concentric co-deposition nozzle. In embodiments which contain a vitamin in the filling component, use of a buffering agent in the filling component helps to slow down the rate of vitamin degradation.

The water activity for each of the filler component and the shell component upon contact in the co-deposition nozzle is preferably less than about 0.7 to assure microbial shelf stability. The water activities of the filling and shell components are preferably at least substantially equal so as to substantially prevent moisture migration and ingredient migration between the shell component and the filling component.

In addition, the solids contents of the filling and shell components upon contact in the co-deposition nozzle are preferably at least substantially equal so as to substantially prevent moisture migration and ingredient migration between the shell component and the filling component. In embodiments of the present invention, the solids contents of the shell component and the filling component may range from about 72% by weight to about 82% by weight, preferably from about 75% by weight to about 80% by weight.

The gellable liquid shell component or shell slurry and the non-gelling liquid filling component or filling slurry may each be produced batch-wise or continuously using conventional mixing, weighing, and heat exchange equipment. To produce the shell component or shell slurry, a gelatin solution, a base slurry, and an optional color solution are prepared and then combined with any additional ingredients such as flavoring ingredients, fruit juices, fruit concentrates, fruit purees, organic acids, and vitamins to obtain a depositing shell slurry for feeding to the Mogul or starch co-deposition equipment.

The gelatin solution for the shell slurry component may be prepared by measuring and combining the specified quantities of gelatin and water, preferably hot water to aid in the dissolution rate, heating the admixture up to about 140° F. to about 150° F. in a boiler, and permitting the gelatin to hydrate for about 30 minutes to obtain a substantially homogeneous gelatin solution.

The optional color solution for the shell slurry component may be prepared by measuring and combining the specified quantities of color and water, preferably hot water, and mixing the ingredients to fully dissolve the color particles and obtain a substantially homogeneous color solution. The weight percentage of the color ingredient may be from about 5% by weight to about 15% by weight, based upon the weight of the color solution.

The base slurry may be prepared by dry blending any additional gelling agent such as pectin or carrageenan with the buffering agent and a portion of the sucrose so as to substantially homogeneously disperse the gelling agent with the other solids to decrease the likelihood of clumping when adding the gelling agent to the wet blend ingredients. The amount of the sucrose used to form the dry blend may range, for example, from about 15% by weight to about 30% by weight, based upon the total amount of sucrose employed in the shell component.

The wet blend for the shell base slurry may be prepared in a batch cooking mode by measuring and combining the specified quantities of water, corn syrups, and the balance of the sucrose in a steam jacketed, well agitated vessel such as a Breddo Liquefier. The steam heat is turned on when the ingredients are added and heating is begun to reach a cooking temperature, generally from about 200° F. to about 300° F., depending upon the gelling agent, for example from about 230° F. to about 240° F. when the gelling agent comprises gelatin and pectin. While the slurry of wet blend ingredients is beginning to heat up, the high shear mixer may be turned on and the shell dry blend may be slowly admixed with the wet blend. When addition of the dry blend is complete, mixing is continued under high shear, generally for about 3 minutes to about 8 minutes, to obtain a substantially homogeneous mixture. The high shear mixer is preferably only pulsed on occasionally so as to minimize aeration of the batch during cooking. Surface agitation is turned on and the resulting slurry is heated until it reaches about 230° F. to about 240° or as hot as necessary to achieve a desired solids content for the cooked base slurry, preferably about 85% to about 87% by weight solids, for example about 86.5% by weight solids, as measured with a calibrated refractometer. In other embodiments of the invention in which a continuous cooking mode is employed, the base slurry may be cooked to a temperature of about 265° F. to about 280° F. and then subjected to vacuum flashing to reduce the temperature to about 180° F. to about 205° F.

The cooked base shell slurry, the gelatin solution, an aqueous acid solution, such as a 50% by weight citric acid solution, and other ingredients such as fruit juice, and flavor and vitamins are admixed together to obtain a desired solids content for example about 78% by weight solids, and a desired temperature, for example about 195° to about 200° F. for the finished shell slurry. The finished shell slurry or gellable liquid shell component may then be transported or fed to the shell side hopper of the mogul or starch co-depositor for co-deposition with the filling component. The mogul hopper may be heated to a temperature nearly or substantially equal to or above the gelling or set up temperature (as previously defined) of the finished shell slurry.

To produce the non-gelling filling component or filling slurry, a filling acid solution, a base syrup, and an optional color solution are prepared and then combined with any additional ingredients such as flavoring ingredients, fruit juices, fruit concentrates, fruit purees, organic acids, and vitamins to obtain a depositing filling slurry for feeding to the Mogul or starch co-deposition equipment.

The filling acid solution for the filling slurry component may be prepared by measuring and combining the specified quantities of organic acids such as citric acid and ascorbic acid, buffering agent, such as sodium citrate, and water, preferably hot water to aid in the dissolution rate, to fully dissolve the acid and to obtain a substantially homogeneous filling acid solution.

The optional color solution for the filling slurry component may be prepared by measuring and combining the specified quantities of color and water, preferably hot water, and mixing the ingredients to fully dissolve the color particles and obtain a substantially homogeneous color solution. The weight percentage of the color ingredient may be from about 1% by weight to about 20% by weight, based upon the weight of the color solution.

The base syrup for the filling component may be prepared by measuring and combining the specified quantities of water, corn syrup, sucrose, fruit ingredient or fruit product and any optional additional sweeteners in a cooking vessel, such as in a steam jacketed, agitated vessel or kettle. The ingredients are cooked to dissolve the sweeteners at a preferred cooking temperature of about 230° F. to about 235° F. or as hot as necessary to fully dissolve the solids and achieve the desired solids content for the cooked syrup, preferably about 75% by weight to about 83% by weight solids, for example about 79.5% by weight solids, as measured with a calibrated refractometer. In embodiments of the invention, the filling syrup may be cooked to higher temperatures, however lower temperatures are preferred to reduce cooling loads.

The cooked syrup may then be cooled down to a desired co-deposition temperature, for example to about 70° F. to about 80° F., or room temperature. The cooling may be achieved by permitting the cooked syrup to sit at ambient conditions or external cooling may be employed, such as a conventional heat exchanger. Heat exchangers which may be employed include coil heat exchangers, plate and frame heat exchangers, shell and tube heat exchangers, and the like.

The cooled, cooked base filling slurry, the filling acid solution, and other ingredients such as fruit juice or other fruit products, and flavor and vitamins are admixed together to obtain a desired solids content for example about 78% by weight solids, and a desired temperature, for example about 70° F. to about 80° F. or room temperature for the finished filling slurry. The finished filling slurry or non-gelling liquid filling component may then be transported or fed to the filling side hopper of the mogul or starch co-depositor for co-deposition with the shell component. The mogul hopper may be cooled or heated to a temperature about equal to or slightly above or below the temperature of the finished filling slurry.

In accordance with embodiments of the present invention for the continuous production of liquid center filled confections on a mass production basis, continuous batching system may be employed such as those commercially available from Klockner, Ter Braak, Bosch, or APV. This system automatically doses the pre-programmed quantity of ingredients by weight using a weigh kettle and dispenses it into a jacketed use kettle. The shell base slurry and the filling base slurry or syrup may be made up in this continuous batching system. The various other solutions, such as the gelatin solution, acid solutions, and color solutions, would be made up in separate kettles. In each case a “Make-up” kettle feeding a “Use” kettle or tank would be employed to provide surge capacity while making up a fresh batch. The “Use” kettle or tempering tank may be maintained at an elevated temperature, such as a temperature of about 160° F. to about 180° F. to prevent flow problems and to reduce heating times in the downstream dissolver and cooker.

A continuous coil cooker, such as a continuous gummy/jelly type coil cooker as available from Klockner, Ter Braak, or Bosch may be used to cook the shell base slurry or syrup as delivered from the batching system's “use” or tempering tank. The system utilizes a coil type cooker and discharges into an atmospheric flash-off tank followed by a vacuum chamber. For example, the shell base slurry may be heated in the coil type cooker to a cooking temperature of about 265° F. to about 280° F. and then flashed in the vacuum flash-off tank to a vacuum of about 5 in. Hg to about 20 in. Hg and a temperature of about 180° F. to about 205° F.

The vacuum cooled shell base slurry may then be sent to a hold tank or surge tank and then mixed with the other ingredients in a conventional in-line mixer or batching pots to obtain the shell component which may then be fed to the shell side of a Mogul or standard center-in-shell (CIS) type depositor as available from NID, Makat, or Winkler and Dunnebier.

For the center or filling base syrup, a continuous dissolver/cooler apparatus may be employed. The center or filling syrup or slurry as received from the batch weigher and tempering tank would first be cooked in a conventional closed heat exchanger, such as a coil, plate and frame, or shell and tube, heat exchanger to dissolve the sugar in a closed environment, and then immediately cooled in a similar heat exchanger so as to not lose any water vapor thereby keeping the solids content at least substantially constant. For example, the filling base syrup or slurry may be heated in the dissolver heat exchanger to a cooking temperature of about 230° F. to about 235° F. and then immediately cooled in the cooler or second exchanger to a desired temperature, for example about 70° F. In other embodiments, the filling base syrup or slurry may be flashed off atmospherically post cook to attain the equilibrium solids content at a given temperature to protect against batching irregularities such as over-charging of water. Subsequently, it could be cooled to the desired final temperature in any of a variety of heat exchangers as previously described.

The cooled filling base syrup or slurry may then be sent to a hold tank or surge tank and then mixed with the other ingredients in a conventional in-line mixer or batching pots to obtain the shell component which may then be fed to the filling side of the Mogul or standard center-in-shell (CIS) type depositor.

After co-deposition into the cavities of the starch trays, the starch trays with product may be cured, for example for about 20 hours to about 30 hours. After curing of the product, the starch trays containing product may follow the industry standard shake-out procedure in which the starch is separated from the confectionary pieces in a series of de-dusters. Then the product may be oiled and polished in a drum with Certicoat® CL 90P (a mineral oil/carnauba wax blend) a coating composition produced by Mantrose-Haeuser Co., Inc., Westport, Conn., or other commonly utilized food grade release agent at an exemplary level of about 0.15% by weight to provide hygroscopic resistance and to minimize the likelihood of products sticking together.

The coated product may then be bagged and packaged in environmentally controlled rooms where the temperature is below about 75° F. and the relative humidity is below about 45%.

The shell component and the filler component may have the same or different flavors and/or colors. The shell component may be transparent or translucent so that the center filling is visible through the shell component. The filling is desirably liquid at room temperature and in embodiments of the invention the shell texture may range from soft and chewy to firm and chewy. The viscosity of the shell component may be relatively low, but still higher than the viscosity of the filler component.

Center-filled confections obtained using the methods of the present invention have substantially uniformly thick walls, and are durable during material handling processes employed after deposition and molding such as oiling, polishing, and packaging. The center filled confections may be produced with substantially uniformly thick top and bottom walls as well as side walls in a wide variety of shapes, such as fruit shapes, gum drop shapes, jelly bean shapes, animal, fish, or plant shapes, and the like. Mold cavities or impressions which have a maximum depth dimension which is substantially the same as or deeper than its largest width-wise dimension, or visa versa may be employed. The products exhibit long term shelf life in bags or pouches without substantial leaking of filler. They are non-sticky, and have a desirable appearance, even when the shell is translucent or transparent thereby making the filler component visible through the shell.

The following examples, wherein all parts, percentages, and ratios are by weight, all temperatures are in ° F., and all pressures are atmospheric pressure unless indicated to the contrary, illustrate the present invention:

### EXAMPLE 1

A liquid center filled fruit snack or gummy product may be produced in accordance with the present invention by preparing a gellable liquid shell component with gelatin and pectin as gelling agents, and a non-gelling liquid filling component. The ingredients, their relative amounts, and the methods of preparation which may be used to produce the shell component and the filling component for co-deposition in a Mogul or starch depositor are:

I. Shell Component or Slurry for Depositing

A gellable liquid shell component for depositing with a Mogul or starch depositor may be obtained by preparing a gelatin solution, and a shell base slurry, and then combining them with other ingredients to obtain a shell component or shell slurry:

1) Preparation of the Gelatin Solution

The ingredients and their relative amounts which may be used to prepare the gelatin solution are:

Gelatin Solution

| | Ingredient | | Batch |
|---|---|---|---|
| | Solids | Batch | Solids |
| Ingredient | (% by wt.) | (% by wt.) | (% by wt.) |
| Gelatin, 250 bloom | 90.00% | 33.33% | 30.00% |
| Hot Water | 0.00% | 66.67% | 0.00% |
| TOTAL | | 100.00% | 30.00% |

The gelatin and water may be combined and heated in a double boiler to a temperature of about 140° F. to about 150° F. with mixing and then permitted to hydrate for about 30 minutes once the temperature is achieved.

2) Preparation of the Shell Base Slurry

The shell base slurry may be prepared by forming a dry blend and a wet blend and then combining the two blends. The ingredients and their relative amounts which may be used to prepare the shell base slurry are:

Shell Base Slurry

| | Batch |
|---|---|
| Ingredients | (% by wt.) |
| Dry Blend: | |
| Pectin 150, a high methoxypectin | 1.53% |
| Sugar | 7.63% |
| Sodium Citrate buffering agent | 0.14% |
| Wet Blend: | |
| Water | 16.13% |
| 62 DE Corn Syrup | 35.24% |
| 42 DE Corn Syrup | 14.09% |
| Sugar | 25.25% |
| TOTAL | 100.00% |

A dry mix or pre-blend of the pectin, a portion of the sugar and sodium citrate buffering agent may be prepared so as to disperse the pectin amongst the other solids so as to decrease the likelihood of clumping when adding to the slurry (wet blend).

The water, 62 DE corn syrup, 42 DE corn syrup, and sugar may be admixed in a steam jacketed, well agitated vessel such as a Breddo Liquefier. The steam heat may be turned on when the ingredient addition is completed and the heating may be continued to obtain a temperature of about 235° F. While the slurry is beginning to heat up, a high shear mixer may be turned on and the dry blend may be slowly added. When the dry mix addition is complete mixing may be continued under high shear for about 5 minutes. The high shear mixer may pulsed on occasionally during this period so as to minimize aeration of the batch during cooking. The swept surface agitation may be turned on and heating or cooking may be continued so that the resulting slurry is heated up to around 230° F. to about 235° F. or as hot as necessary to achieve about 86.5% solids by weight as measured using a calibrated refractometer.

3. Combining all of the Shell Ingredients

The cooked base slurry, gelatin solution, and remaining ingredients may then be combined to obtain the gellable, liquid shell component or slurry for deposition. The ingredients and their relative amounts which may be used to obtain the depositing shell slurry are:

Depositing Shell Slurry

| | Batch |
|---|---|
| Ingredient | (% by wt.) |
| Cooked base slurry | 76.78% |
| Gelatin Solution | 12.07% |
| 50% Citric acid solution | 2.20% |
| White grape juice | 8.75% |
| Flavor | 0.20% |
| TOTAL | 100.00% |

The cooked base slurry, grape juice, the citric acid solution, the gelatin solution, and the flavor may be admixed to obtain a substantially homogeneous finished slurry with a final solids content of about 78% by weight and a temperature of about 185° F. to about 200° F. The finished slurry may be placed in the shell side hopper of an NID Printer Depositor or Mogul for co-deposition at a temperature of about 185° F. to about 200° F. The shell hopper jacket temperature may be set to about the same temperature of the shell to help maintain the shell temperature or at just above the shell setting temperature as previously defined.

The shell component may have a specific gravity of about 1.3198 at 198° F. and 78% by weight solids. The viscosity of the shell component measured with a Stress rheometer may be about 100 poise at 85° C.

II. Filling Component or Slurry for Depositing

A non-gelling, single phase, non-emulsified liquid filling component or slurry for depositing with the Mogul or starch depositor may be obtained by preparing a filling acid solution, a filling base slurry, a color solution, and then combining them with other ingredients to obtain a filling component or filling slurry:

1) Preparation of the Filling Acid Solution

The ingredients and their relative amounts which may be used to prepare the filling acid solution are:

Filling Acid Solution

| | Batch |
|---|---|
| Ingredient | (% by wt.) |
| Citric acid | 21.67% |
| Sodium Citrate | 17.98% |
| Ascorbic Acid | 4.98% |
| Hot Water | 55.37% |
| TOTAL | 100.00% |

The filling acid solution may be prepared by admixing the water, sodium citrate, ascorbic acid and citric acid in mixing vessel to fully dissolve the solid ingredients in the water.

2) Preparation of the Filling Base Syrup

The ingredients and their relative amounts which may be used to prepare the filling base syrup are:

Filling Base Syrup

| | Batch |
|---|---|
| Ingredient | (% by weight) |
| Hot Water | 14.2 |
| Sugar | 42.9 |
| 62 DE Corn Syrup | 42.9 |
| TOTAL | 100% |

The hot water, sugar and corn syrup may be added to a cooking vessel and heated and admixed to dissolve the solids and cook the ingredients at a temperature of about 230° F. to a solids content of about 79.5% by weight solids. The cooked slurry may then be cooled down to a temperature of about 60° F. to about 80° F.

3) Preparation of the Color Solution

The ingredients and their relative amounts which may be used to prepare a 10% by weight color solution are:

10% Red Solution

| | Ingredient | | Batch |
|---|---|---|---|
| | Solids | Batch | Solids |
| Ingredient | (% by wt.) | (% by wt.) | (% by wt.) |
| Red #40 dye | 100.00% | 10.00% | 10.00% |
| Hot Water | 0.00% | 90.00% | 0.00% |
| TOTAL | | 100.00% | 10.00% |

The color solution may be prepared by admixing the red dye with the water to fully dissolve the color particles.

4) Combining all of the Center or Filling Ingredients

The filling acid solution, cooked filling base syrup, coloring solution, and remaining ingredients may then be combined to obtain the non-gelling, liquid filling component or slurry for deposition. The ingredients and their relative amounts which may be used to obtain the depositing center filling slurry are:

Depositing Center Filling Slurry

| | Batch |
|---|---|
| Ingredient | (% by wt.) |
| Cooked Filling Base Syrup | 92.47% |
| Filling Acid Solution | 6.23% |
| Flavor | 0.10% |
| Color Solution | 1.2% |
| TOTAL | 100.00% |

The cooked filling base syrup, filling acid solution, flavor, and color solution may be admixed to obtain a substantially homogeneous finished slurry with a final solids content of about 78% by weight and a temperature of about 65° F. to about 80° F. The color strength may be adjusted to achieve a filling slurry solids content of 78% by weight. The finished slurry may be placed in the filling side hopper of the NID Printer Depositor or Mogul for co-deposition at a temperature of about 65° F. to about 80° F. The filling hopper jacket temperature may be set to about the same temperature of the filling to help maintain the filling temperature.

The filling component may have a specific gravity of about 1.3888 at 100° F. and 78% by weight solids, and a specific gravity of about 1.3977 at 75° F. and 78% by weight solids. The viscosity of the filling component measured with a Stress Rheometer may be about 24 poise at 25° C. and 1.31 poise at 85° C.

III. Depositing the Liquid Center Filled Piece

Using a CIS (Center in Shell) manifold set-up for the NID co-depositor or Mogul, the liquid filled pieces may be deposited into the cavities of starch trays. Upon contact of the two components in the concentric co-deposition nozzle of the Mogul or co-depositor, the temperature of the gellable liquid shell component may be about 195° F. to about 200° F., and the temperature of the non-gelling liquid filling component may be about 75° F. to about 80° F. Upon contact, the specific gravity of the filling component may be about 5.5% greater than the specific gravity of the shell component. The Printer Depositor settings which may be employed to deliver an about 3.3 gm wet weight are:

| Hopper #1: | | Hopper #2: |
|---|---|---|
| Shell | Speeds | Center |
| 59% Stroke | 25% Hopper #1 | 92% Start |
| 10% Suck back | 15% Hopper #2 | 37% Stroke |
| 20 micron up delay | | 20% Suck back |

The filling component may be initially deposited so that the center point is at about 65% of the maximum vertical dimension of the piece instead of at 50%, or a vertical offset of about 15%. For a piece having a maximum vertical dimension of about 17 mm and a maximum vertical filling dimension along the same vertical line of about 8 mm, the initial vertical displacement would be about 56.7%. If the filling sinks 4 mm during curing of the shell, the final vertical displacement may be about 32.2%, with the bottom wall having a substantially uniform thickness of about 3 mm and the top wall having a substantially uniform thickness of about 6 mm. The weight percentage of the filling component in the final piece may be about 15% by weight, based upon the total weight of the filling component and the shell.

After depositing into the starch trays, the pieces of completely enrobed filling may be cured for 24 hours in the same vertical position in which they were deposited. The curing may be in a conditioned environment at 75° F. and 30% relative humidity.

After curing, the product may be separated from the starch mold by picking out the individual pieces and then using compressed air to blow them clean.

The pieces may be oiled by applying a coating of Certicoat CL 90P (a mineral oil/carnauba wax blend) at a 0.15% level by weight.

The finished product pieces may be packaged in a metallized or foil-lined bag until ready for consumption to prevent the product from drying out over a prolonged period of time.

### EXAMPLE 2

A liquid center filled fruit snack or gummy product may be produced in accordance with the present invention by preparing a gellable liquid shell component with carrageenan as a gelling agent, and a non-gelling liquid filling component. The ingredients, their relative amounts, and the methods of preparation which may be used to produce the shell component and the filling component for co-deposition in a Mogul or starch depositor are:

I. Shell Component or Slurry for Depositing

A gellable liquid shell component for depositing with a Mogul or starch depositor may be obtained by preparing a dry blend of carrageen and a portion of the sugar, and a shell base slurry, and then combining them with other ingredients to obtain a shell component or shell slurry:

1) Preparation of the Carrageenan-Sugar Dry Blend

The ingredients and their relative amounts which may be used to prepare the carrageenan-sugar mix are:

Carrageenan - Sugar Mix

| | Batch |
|---|---|
| Ingredient | (% by wt.) |
| Carrageenan (FMC Gelcarin) | 20.33% |
| Sucrose | 80.00% |
| TOTAL | 100.00% |

The carrageenan and sucrose are dry-blended together to obtain a substantially homogeneous mixture which helps to reduce clumping of the carrageenan upon combining with the wet ingredients.

2) Preparation of the Shell Base Slurry

The shell base slurry may be prepared by combining the carrageenan-sugar mix or dry blend with a wet blend containing the remaining sucrose and corn syrup. The ingredients and their relative amounts which may be used to prepare the shell base slurry are:

Shell Base Slurry

| | Batch |
|---|---|
| Ingredients | (% by wt.) |
| Carrageenan-Sugar Mix | 9.05% |
| 42 DE Corn Syrup | 45.38% |
| Sucrose | 30.57% |
| Water | 15.00% |
| TOTAL | 100.00% |

The water, 42 DE corn syrup, and sugar may be admixed in a steam jacketed, well agitated vessel such as a Breddo Liquefier to obtain a wet blend. The steam heat may be turned on when the ingredient addition is completed and the heating may be continued to obtain a temperature of about 220° F. to about 235° F. While the slurry is beginning to heat up, a high shear mixer may be turned on and the dry blend carrageenan-sugar mix may be slowly added. When the dry mix addition is complete mixing may be continued under high shear for about 5 minutes. The high shear mixer may pulsed on occasionally during this period so as to minimize aeration of the batch during cooking. The swept surface agitation may be turned on and heating or cooking may be continued so that the resulting slurry is heated up to around 220° F. to about 225° F. or as hot as necessary to achieve about 81% solids by weight as measured using a calibrated refractometer.

3. Combining all of the Shell Ingredients

The cooked base slurry and remaining ingredients may then be combined to obtain the gellable, liquid shell component or slurry for deposition. The ingredients and their relative amounts which may be used to obtain the depositing shell slurry are:

Depositing Shell Slurry

| | Batch |
|---|---|
| Ingredient | (% by wt.) |
| Cooked base shell slurry | 91.20% |
| 33.3% by wt. Sodium citrate solution | 2.40% |
| 50% by wt. Citric acid solution | 2.00% |
| White grape juice concentrate | 4.00% |
| Flavor | 0.40% |
| TOTAL | 100.00% |

The cooked base slurry, grape juice concentrate, the citric acid solution, the sodium citrate solution, and the flavor may be admixed to obtain a substantially homogeneous finished slurry with a final solids content of about 78% by weight and a temperature of about 200° F. The finished slurry may be placed in the shell side hopper of an NID Printer Depositor or Mogul for co-deposition at a temperature of about 200° F. The shell hopper jacket temperature may be set to about 200° F., the same temperature of the shell, to help maintain the shell temperature.

II. Filling Component or Slurry for Depositing

A non-gelling, single phase, non-emulsified liquid filling component or slurry for depositing with the Mogul or starch depositor may be obtained by preparing a filling acid solution, a color solution, and then combining them with other ingredients to obtain a filling component or filling slurry:

1) Preparation of the Filling Acid Solution

The ingredients and their relative amounts which may be used to prepare the filling acid solution are:

Filling Acid Solution

| | Batch |
|---|---|
| Ingredient | (% by wt.) |
| Citric acid | 18.75% |
| Sodium Citrate | 19.79% |
| Acerola Extract | 16.67% |
| Hot Water | 44.79% |
| TOTAL | 100.00% |

The filling acid solution may be prepared by admixing the water, sodium citrate, acerola extract, and citric acid in mixing vessel to fully dissolve the solid ingredients in the water.

3) Preparation of the Color Solution

The ingredients and their relative amounts which may be used to prepare a 10% by weight color solution are:

10% Color Solution

| | Ingredient | | Batch |
|---|---|---|---|
| | Solids | Batch | Solids |
| Ingredient | (% by wt.) | (% by wt.) | (% by wt.) |
| Red and yellow dyes | 100.00% | 10.00% | 10.00% |
| Hot Water | 0.00% | 90.00% | 0.00% |
| TOTAL | | 100.00% | 10.00% |

The color solution may be prepared by admixing the dyes with the water to fully dissolve the color particles.

3) Combining all of the Center or Filling Ingredients

The filling acid solution, coloring solution, and remaining ingredients may then be combined to obtain the non-gelling, liquid filling component or slurry for deposition. The ingredients and their relative amounts which may be used to obtain the depositing center filling slurry are:

Depositing Center Filling Slurry

| | Batch |
|---|---|
| Ingredient | (% by wt.) |
| 62 DE Corn Syrup | 89.55% |
| Filling Acid Solution | 9.60% |
| Flavor | 0.10% |
| Color Solution | 0.75% |
| TOTAL | 100.00% |

The corn syrup, filling acid solution, flavor, and color solution may be admixed at room temperature to obtain a substantially homogeneous finished slurry with a final solids content of about 78% by weight and a temperature of about 70° F. The color strength may be adjusted to achieve a filling slurry solids content of 78% by weight. The finished slurry may be placed in the filling side hopper of the NID Printer Depositor or Mogul for co-deposition at a temperature of about 70° F. The filling hopper jacket temperature may be set to about 70° F., the same temperature of the filling, to help maintain the filling temperature.

III. Depositing the Liquid Center Filled Piece

Using a CIS (Center in Shell) manifold set-up for the NID co-depositor or Mogul, the liquid filled pieces may be deposited into the cavities of starch trays. Upon contact of the two components in the concentric co-deposition nozzle of the Mogul or co-depositor, the temperature of the gellable liquid shell component may be about 200° F., and the temperature of the non-gelling liquid filling component may be about 70° F. Upon contact, the specific gravity of the filling component may be about 4.5% greater than the specific gravity of the shell component. The Printer Depositor settings which may be employed to deliver an about 3.3 gm wet weight are:

| Hopper #1: | | Hopper #2: |
|---|---|---|
| Shell | Speeds | Center |
| 59% Stroke | 25% Hopper #1 | 92% Start |
| 10% Suck back | 15% Hopper #2 | 37% Stroke |
| 20 micron up delay | | 20% Suck back |

The filling component may be initially deposited so that the center point is at about 65% of the maximum vertical dimension of the piece instead of at 50%, or a vertical offset of about 15%. For a piece having a maximum vertical dimension of about 17 mm and a maximum vertical filling dimension along the same vertical line of about 8 mm, the initial vertical displacement would be about 56.7%. If the filling sinks 2 mm during curing of the shell, the final vertical displacement may be about 17.2%, with the bottom wall having a substantially uniform thickness of about 5 mm and the top wall having a substantially uniform thickness of about 4 mm. The weight percentage of the filling component in the final piece may be about 15% by weight, based upon the total weight of the filling component and the shell.

After depositing into the starch trays, the pieces of completely enrobed filling may be cured for 24 hours in the same vertical position in which they were deposited. The curing may be in a conditioned environment at 75° F. and 30% relative humidity.

After curing, the product may be separated from the starch mold by picking out the individual pieces and then using compressed air to blow them clean.

The pieces may be oiled by applying a coating of Certicoat CL 90P (a mineral oil/carnauba wax blend) at a 0.15% level by weight.

The finished product pieces may be packaged in a metallized or foil-lined bag until ready for consumption to prevent the product from drying out over a prolonged period of time.

1. A method for producing liquid center filled confections comprising:
a. contacting a non-gelling, liquid filling component having a temperature of less than or equal to about 120° F. and a gellable, liquid shell component comprising at least one gelling agent and having a temperature of about 160° F. to about 220° F. in a concentric nozzle to partially enrobe the liquid filling component within the shell component, said at least one gelling agent comprising from about 0.5% by weight to about 5% by weight of pectin and/or carrageenan, based upon the weight of said gellable, liquid shell component, said shell component and said filling component having specific gravities which differ from each other by at least about 2.5%,
b. depositing the partially enrobed liquid filling component in a cavity of a starch mold,
c. completely enrobing the liquid filling component within the shell component so that the liquid filling component is initially vertically displaced from the center of the confection and the amount of said liquid filling component is at least about 10% by weight, based upon the total weight of the liquid filling component and the shell component, and
d. gelling or setting the shell component within the mold cavity wherein the filling component cools the liquid shell component to cause gelling or setting of the liquid shell component which prevents substantial vertical migration of the liquid filling component within the shell component so that the liquid filling component is substantially centered between top and bottom walls of gelled or set shell component.

2. A method for producing liquid center filled confections as claimed in claim 1 wherein said liquid filling component has a temperature of less than about 75° F. upon contacting said shell component.

3. A method for producing liquid center filled confections as claimed in claim 1 wherein said liquid shell component has a temperature of from about 180° F. to about 200° F. upon contact with said liquid filling component.

4. A method for producing liquid center filled confections as claimed in claim 2 wherein said liquid shell component has a temperature of from about 180° F. to about 200° F. upon contact with said liquid filling component.

5. A method for producing liquid center filled confections as claimed in claim 4 wherein said liquid filling component has a temperature of about 45° F. to about 70° F. upon contacting said shell component.

6. A method for producing liquid center filled confections as claimed in claim 1 wherein said at least one gelling agent comprises pectin and gelatin.

7. A method for producing liquid center filled confections as claimed in claim 1 wherein the water activities of the shell component and the filling component are substantially the same.

8. A method for producing liquid center filled confections as claimed in claim 1 wherein the solids contents of the shell component and the filling component are substantially the same.

9. A method for producing liquid center filled confections as claimed in claim 1 wherein the specific gravities of the shell component and the filling component differ from each other by at least about 5% upon contact with each other within the nozzle and upon deposition into the mold cavity.

10. A method for producing liquid center filled confections as claimed in claim 1 wherein upon deposition into the starch mold cavity the viscosity of the liquid shell component is greater than the viscosity of the liquid filler component but sufficiently low so as to avoid substantial candy tailing.

11. A method for producing liquid center filled confections as claimed in claim 1 wherein the starch of said starch mold is cooled to a temperature of less than about 85° F. prior to depositing of the partially enrobed filling component into the mold cavity.

12. A method for producing liquid center filled confections as claimed in claim 1 wherein the specific gravity of said liquid filling component is greater than the specific gravity of said liquid shell component, the liquid filling component is vertically displaced above the center of the confection prior to complete gelling or setting of the shell component, and the liquid filling component descends or sinks so that upon completion of gelling or setting of the shell component the liquid filling component is substantially centered between top and bottom walls of gelled or set shell component.

13. A method for producing liquid center filled confections as claimed in claim 12 wherein the specific gravity of the liquid filling component is at least about 3% greater than the specific gravity of the shell component upon deposition into the mold cavity.

14. A method for producing liquid center filled confections as claimed in claim 1 wherein the specific gravity of said liquid filling component is less than the specific gravity of said liquid shell component, the liquid filling component is vertically displaced below the center of the confection prior to complete gelling or setting of the shell component, and the liquid filling component ascends or rises so that upon completion of gelling or setting of the shell component the liquid filling component is substantially centered between top and bottom walls of gelled or set shell component.

15. A method for producing liquid center filled confections as claimed in claim 14 wherein the specific gravity of the liquid filling component is at least about 5% less than the specific gravity of the shell component upon deposition into the mold cavity.

16. A method for producing liquid center filled confections as claimed in claim 12 wherein said liquid center filled confection is a gummy or jelly fruit snack.

17. A method for producing liquid center filled confections as claimed in claim 1 wherein said gelling agent comprises pectin and gelatin in a total amount of from about 1% by weight to about 8% by weight, based upon the weight of the gellable, liquid shell component.

18. A method for producing liquid center filled confections as claimed in claim 17 wherein said non-gelling, liquid center filling component is a non-emulsified, single phase component comprising at least one member selected from the group consisting of corn syrups and sucrose.

19. A method for producing liquid center filled confections as claimed in claim 1 wherein said gelling agent is carrageenan.

20. A method according to claim 1 wherein said at least one gelling agent is pectin and gelatin.

21. A method according to claim 1 wherein upon contact with said liquid filling component, said liquid shell component has a temperature of from about 1° F. to about 15° F. higher than the gelling temperature of the liquid shell component.

22. A method according to claim 1 wherein upon contact with said liquid filling component, said liquid shell component has a temperature of from about 5° F. to about 10° F. higher than the gelling temperature of the liquid shell component.

23. A method as claimed in claim 1 wherein the percentage vertical displacement of the filling component upon initial deposition is about 25% to about 50%.

24. A method for reducing vertical decentering of liquid center filled gummy, jelly or fruit snack confections produced by starch deposition comprising
a. contacting a non-gelling, liquid filling component having a temperature of less than or equal to about 120° F. and a gellable, liquid shell component comprising at least one gelling agent and having a temperature of about 160° F. to about 220° F. in a concentric nozzle to partially enrobe the liquid filling component within the shell component, said at least one gelling agent comprising from about 0.5% by weight to about 5% by weight of pectin and/or carrageenan, based upon the weight of said gellable, liquid shell component, said filling component having a specific gravity which is about 3% to about 10% greater than the specific gravity of the shell component,
b. depositing the partially enrobed liquid filling component in a cavity of a starch mold,
c. completely enrobing the liquid filling component within the shell component so that the amount of said liquid filling component is at least about 10% by weight, based upon the total weight of the liquid filling component and the shell component, and
d. gelling or setting the shell component within the mold cavity wherein the filling component cools the liquid shell component to cause gelling or setting of the liquid shell component which prevents substantial vertical migration of the liquid filling component within the shell component so that the liquid filling component is substantially centered between top and bottom walls of gelled or set shell component.

25. A method as claimed in claim 24 wherein said gelling agent comprises pectin and gelatin in a total amount of from about 1% by weight to about 8% by weight, based upon the weight of the gellable, liquid shell component, and said non-gelling, liquid center filling component is a non-emulsified, single phase component comprising corn syrups and sucrose.

26. A method for producing liquid center filled confections as claimed in claim 25 wherein said liquid shell component has a temperature of from about 180° F. to about 200° F. upon contact with said liquid filling component.

27. A method for producing liquid center filled confections as claimed in claim 26 wherein said liquid filling component has a temperature of about 45° F. to about 70° F. upon contacting said shell component.

28. A method for producing liquid center filled confections as claimed in claim 24 wherein said at least one gelling agent is carrageenan.

29. A method as claimed in claim 24 wherein said at least one gelling agent is pectin and gelatin.

30. A method as claimed in claim 24 wherein upon contact with said liquid filling component, said liquid shell component has a temperature of from about 1° F. to about 15° F. higher than the gelling temperature of the liquid shell component.

31. A method as claimed in claim 24 wherein upon contact with said liquid filling component, said liquid shell component has a temperature of from about 5° F. to about 10° F. higher than the gelling temperature of the liquid shell component.

32. A method as claimed in claim 24 wherein the percentage vertical displacement of the filling component upon initial deposition is about 25% to about 50%.
